(19) United States
(12) Patent Application Publication
(10) Pub. No.: US 2009/0092057 A1
(43) Pub. Date: Apr. 9, 2009

(54) Network Monitoring System with Enhanced Performance

(75) Inventors: Brad B. Doctor, Golden, CO (US); James David Brown, Broomfield, CO (US)

Correspondence Address: HENSLEY KIM & HOLZER, LLC, 1660 LINCOLN STREET, SUITE 3000, DENVER, CO, 80264, US

(73) Assignee: LATIS NETWORKS, INC., Superior, CO (US)

(21) Appl. No.: 12/248,746

(22) Filed: Oct. 9, 2008

Related U.S. Application Data
(60) Provisional application No. 60/978,651, filed on Oct. 9, 2007.

(51) Int. Cl. H04J 1/16

(52) U.S. Cl. 370/252

(57) ABSTRACT

A data packet inspection and/or filtering system monitors packet traffic across an interface. In the case of monitoring incoming traffic, the incoming packets are directed to a packet capture process associated with a kernel of an operating system. The packets are then stored in shared memory of the kernel for access by a user space application that inspects the packets without requiring copying of the packets to user space and back to kernel space.

### CROSS-REFERENCE TO RELATED APPLICATION

This application claims priority under 35 U.S.C. 120 to U.S. Provisional Application No. 60/978,651, entitled, “Network Monitoring System with Enhanced Performance,” filed on Oct. 9, 2007, the contents of which are incorporated herein as if set forth in full. This application is further related to U.S. Non-Provisional application Ser. No. 12/031,513 entitled, “Intrusion Detection System/Intrusion Prevention System With Enhanced Performance,” filed on Feb. 14, 2007, the contents of which are incorporated herein as if set forth in full.

### FIELD OF INVENTION

The presently disclosed technology relates to network monitoring, traffic analysis, and filtering systems including but not limited to intrusion detection systems (IDSs) and intrusion prevention systems (IPSs).

### BACKGROUND

A variety of network monitoring applications are employed by network administrators or others, and it is anticipated that this will be an area of continued development. Typically, these applications monitor traffic across one or more network interfaces of interest on a packet-by-packet basis, with respect to a series of packets, or otherwise at a fine level of granularity in relation to deployed data rates. These applications may simply inspect traffic or may be involved in actively filtering traffic. For example, an inspection application may inspect packets so as to report traffic levels or levels of different kinds of traffic or activities. The results may be displayed on a dashboard or similar display monitored by a network administrator. A filtering application may analyze packets and then selectively filter the packets based on the analysis, e.g., pass, drop or modify packets. In any event, these applications generally involve real-time inspection of packets or groups of packets at an interface of interest by a user space application.

The case of IDS and IPS applications is illustrative. A number of strategies have been developed to detect likely intrusion attempts or events, such as worms, Trojans, spyware, port scans, DoS and DDoS attacks, server export attempts and viruses. These strategies generally involve, at least in part, real-time monitoring of traffic across protected interfaces. Conventional IDSs and IPSs have struggled to keep up with deployed data rates due to, for example, slow PC busses, an inefficient interface between the CPU and core system memory, insufficient CPU power and limited operating system capabilities. In this regard, multi-gig processing speeds are now desirable to effectively implement IDS and IPS functionality in some environments.

Proposals to provide the desired processing speed reflect the perception that current off the shelf hardware and software cannot provide the desired speed or are unreliable. In particular, such proposals have included purpose built appliances with ASICs network processing hardware acceleration cards and/or other custom hardware upgrades. However, such approaches are expensive, inflexible and may not scale well to meet changing processing requirements.

### SUMMARY

The presently disclosed technology is directed to providing improved data packet throughput for network monitoring systems involving packet inspection analysis. More specifically, the presently disclosed technology allows for packet inspection processing while only making a single copy of the packet under analysis. In one particular implementation, for example, a packet capture process can be modified such that a custom kernel extension is the first call a device driver makes into the kernel. The packet is then copied into a designated, shared memory segment that is mapped to user space, or otherwise made available to applications in user space. A user space application can then poll the shared memory space, inspect the packet, and optionally notify the kernel that the packet was inspected. The custom kernel extension then inserts the packet back into the network stack. By virtue of the enhanced efficiency, fast packet inspection processing including, but not limited to, IDS/IPS processing is accommodated in-line or out-of-line and the system is scalable with faster hardware, e.g., multi-core processors such as quad-core CPUSs and other multi-core systems in development.

In accordance with one aspect of the presently disclosed technology, a method and apparatus (“utility”) is provided for in-line analysis of packets by a user space process, such as, but not limited to, an IPS or a network policy enforcement process. Other exemplary processes where the presently disclosed technology may be utilized include, but are not limited to, routing applications, network address translation (NAT), firewalling (network or application based), content filtering, email gateways, file sharing, and proxy servers. The utility involves establishing a mandatory path for packet transmission across a network and monitoring the path for a packet or series of packets of interest for processing by the user space process.

In accordance with another aspect of the presently disclosed technology, a utility allows a user space network monitoring application to access a shared kernel memory segment so as to enhance data throughput. The utility involves allocating a shared kernel memory segment, e.g., a ring buffer or other designated memory such as hardware-provided DMA, for access by the user space application and using the allocated shared kernel memory segment to store packets for processing by the user space application.

### BRIEF DESCRIPTION OF THE DRAWINGS

For a more complete understanding of the presently disclosed technology and further advantages thereof, reference is now made to the following detailed description taken in conjunction with the drawings in which:

FIG. 1 is a data flow diagram illustrating a conventional IPS according to the current state of the art.

FIG. 2 is a data flow diagram illustrating a conventional IDS according to the current state of the art.

FIG. 3 is a data flow diagram illustrating an inspection system in accordance with the presently disclosed technology.

FIG. 4 is a data flow diagram illustrating an IPS implementation of the inspection module depicted in FIG. 3.

FIG. 5 is a data flow diagram illustrating an IDS implementation of the inspection module depicted in FIG. 3.

FIG. 6 is a data flow diagram illustrating the shared memory and the interaction between kernel space and user space as contemplated in FIGS. 4 and 5;

FIG. 7 is a process flow diagram illustrating an IPS traffic inspection and filtering process in accordance with the presently disclosed technology; and

FIG. 8 is a process flow diagram illustrating an IDS traffic inspection process in accordance with the presently disclosed technology.

FIG. 9 is an exemplary computer system for implementing the presently disclosed technology.

### DETAILED DESCRIPTION

The presently disclosed technology is directed to a method and apparatus for improving the throughput of a data packet inspection system. In particular, by implementing kernel extensions that are specific to the packet inspection task, relatively higher speeds (e.g. multi-gig speeds) can be achieved. For example, conventional IPS approaches in this regard have generally made at least four copies of each packet for inspection by the user space IPS process. Specifically, an incoming packet from the network interface card (NIC) is copied to provide a new packet. The new packet is then copied to user space for access by the IDS/IPS process. The inspection process is then implemented, and the resulting inspected packet is then copied back from user space. Finally, the original packet is copied back to the network stack.

For example, conventional IDS approaches in this regard have generally made at least two copies of each packet for inspection by the user space IDS process. Further, the conventional IDS approach is an out-of-line system and thus cannot guarantee inspection of every incoming packet. More specifically, if the flow of data from the NIC exceeds the data inspection capacity of the IDS, packets may be missed by the IDS.

In accordance with one aspect of the presently disclosed technology, a method and apparatus (“utility”) is provided for in-line analysis of packets by a user space process, such as, but not limited to, an IPS or a network policy enforcement process. The utility involves establishing a mandatory path for packet transmission across a network and monitoring the path for a packet or series of packets of interest for processing by the user space process. For example, the mandatory path may be implemented by the packet capture mechanism of an operating system (e.g., Linux, Windows, or MAC OS X). Upon identification of a packet of interest, the user space process is employed to perform an analysis on the packet and provide a substantially real-time output that is dependent on the results of the analysis.

For example, the analysis may result in a pass/fail determination that is reported to the kernel to implement a filtering function. In this regard, a conventional IDS, a conventional IPS, an application executing a company network use policy, or other application/project involving a pass/fail determination may be employed. The packet capture process is then operated to selectively allow or disallow the packet to pass the protected interface of the network based on the pass/fail determination. Alternatively, the output may result in modifying the contents of selected packets, or reporting traffic levels/composition. It will be appreciated that the references above to particular applications or processes are merely for purposes of illustration, and the disclosed technology is not limited to any such particular processes or contexts.

In accordance with another aspect of the presently disclosed technology, a utility allows a user space network monitoring application to access a shared kernel memory segment so as to enhance data throughput. The utility involves allocating a shared kernel memory segment, e.g., a ring buffer or other designated memory such as hardware-provided DMA, for access by the user space application and using the allocated shared kernel memory segment to store packets for processing by the user space application. The user space application is operated to perform an analysis on at least one packet in the shared kernel memory segment. The kernel is then operated to process the packet in a manner dependent on a result of the analysis.

In one implementation, the step of allocating involves receiving a request, from the user space application via an application programming interface (API), regarding allocation of the shared kernel memory segment and allocating the shared kernel memory segment in response to the request. Once the memory segment has been allocated, a network interface is monitored such that incoming and/or outgoing packets can be directed to the shared kernel memory segment. The user space application can then periodically poll the shared memory segment for new data and perform an analysis on the new data. For example, the analysis may involve a pass/fail determination. Based on the result of the pass/fail determination, the packet can either be passed through the network stack or a portion of the shared memory associated with the data can be de-allocated.

Alternatively or additionally, the analysis may involve identifying content subject to a rule regarding transmission across a monitored interface. For example, the new data in the shared memory may be analyzed to identify a predetermined pattern corresponding to, e.g., a social security number or other data deemed sensitive according to a network policy. When such information is identified, the relevant data portion may be removed or replaced. For example, an API call may be used to notify the kernel that packets will potentially be filtered, and/or modified, not just viewed. In this regard, when the user space application determines that a packet is fragmented, a partial match-and-replace can be formed over multiple packets. The user space application may perform both a pass/fail analysis and a detect-and-remove/replace analysis on the same set of data. By virtue of the noted shared memory implementation, the data can be analyzed and otherwise processed efficiently, thereby enhancing throughput at the monitored interface.

The presently disclosed technology may be implemented using PC class or current off the shelf (COTS) hardware. Further, the presently disclosed technology may be implemented on PC class operating systems, e.g., Linux, Microsoft Windows, and MAC OS, thus eliminating the need for purpose built hardware and custom software for many environments. An associated process involves: establishing a network connection with a computer having PC class hardware and a PC class operating system including a PC class kernel; and operating the computer to inspect traffic, across an interface between the computer and the network, on a packet-by-packet basis. The presently disclosed technology may further implement a packet filtering determination with respect to the packets. The step of operating may involve inspecting the traffic at a rate of at least about 200 Mbps. More preferably, the traffic is filtered at a rate of at least about 1 Gbps. In one implementation, a filtering rate of at least about 2.33 Gbps has been achieved.

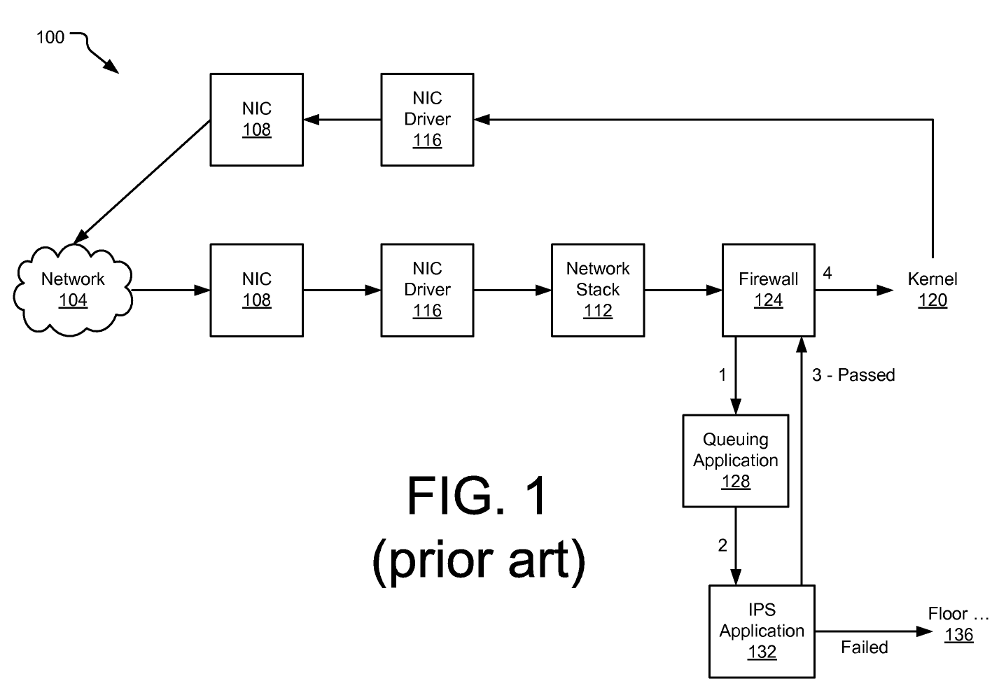

FIG. 1 is a data flow diagram illustrating a conventional IPS 100 according to the current state of the art. FIG. 1 illustrates that four copies of each data packet for inspection must be made for the packet to pass through the conventional IPS 100. In this embodiment, incoming packets from a network 104 enter the conventional IPS 100 via network interface cards (NICs) 108. The packets are then sent to a network stack 112 via a NIC driver 116. However, for the packets to pass through the network stack 112, they must first pass through a firewall 124, e.g., iptables. The firewall 124 is an ideal place to queue the packets for IPS analysis; however, the packets may be queued from a different point in the network stack 112. A queuing application 128, e.g., nf_queue, is used queue each packet for manipulation in user space by making a copy of it. This is the first copy of the packet made by the conventional IPS 100.

Then an IPS Application 132, e.g., Snort or Untangle, copies the packet from the queuing application 128 for analysis. More specifically, the IPS application 132 may perform protocol analysis, content searching/matching, and/or actively block a variety of attacks and probes, such as buffer overflows, stealth port scans, web application attacks, server message block (SMB) probes, and operating system (OS) fingerprinting attempts, amongst other features. This is the second copy of the packet made by the conventional IPS 100.

If the packet fails the analysis performed by the IPS Application 132, the packet is dropped to the floor 136. Packets are dropped either by de-allocation of the memory space they occupy or by deletion from memory. If the packet passes the IPS application 132 analysis, it is copied back to kernel space. This is the third copy of the packet made by the conventional IPS 100.

Finally, a kernel 120 allows passed packets to be copied back to the network stack 112 and allowed to pass back to the NIC 108 via the NIC driver 116 and back out to the network 104. This is the fourth copy of the packet made by the conventional IPS 100. Significantly, the packet is copied at least four times in a conventional IPS 100, whereas, in the inspection system 300 according to the presently disclosed technology, only one copy is required to perform the IPS function.

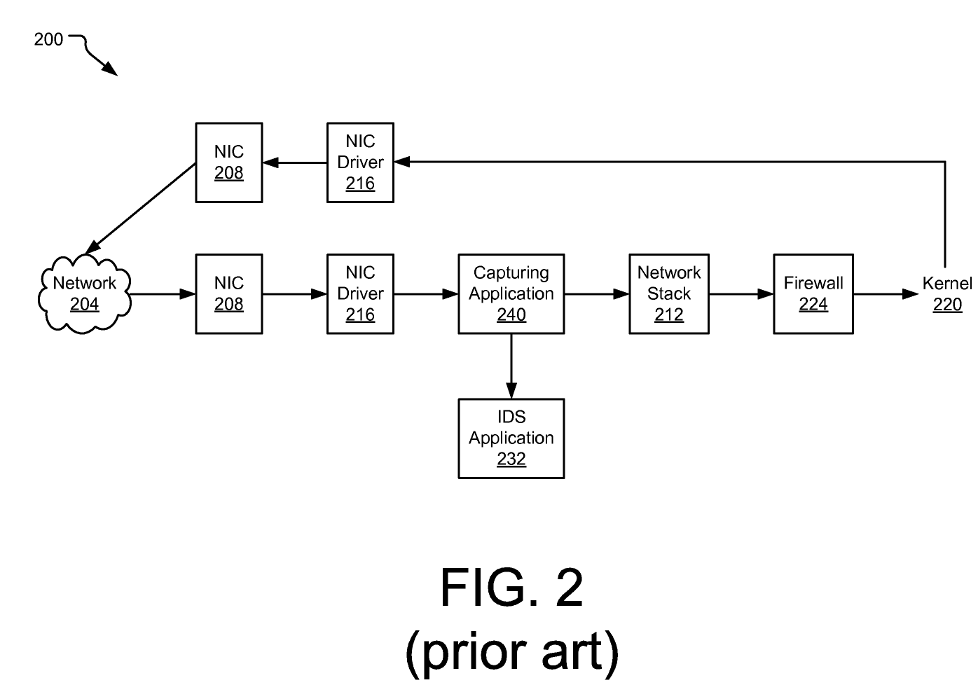

FIG. 2 is a data flow diagram illustrating a conventional IDS 200 according to the current state of the art. While FIG. 2 illustrates that four copies of each packet for inspection are not required for the conventional IDS 200 to operate, the conventional IDS 200 is not an in-line system like the conventional IPS 100. In addition, at least two copies of each packet are still required for the conventional IDS to operate. In this embodiment, incoming packets from a network 204 enter the conventional IDS 200 via network interface cards (NICs) 208. The packets are then sent to a network stack 212 via a NIC driver 216.

A capturing application 240, e.g., pcap, libpcap, and/or winpcap, polls the data path from the NIC driver 216 to the network stack 212 and captures packets for analysis. The capturing application 240 copies selected packets from the data path in kernel space to user space where an IDS application 232, e.g., Snort NIDS or Untangle, can perform an analysis on the selected packets. This is the first copy of the packet made by the conventional IDS 200. More specifically, the IDS application 232 may detect unwanted attempts at accessing, manipulating, and/or disabling of computer systems.

Because the conventional IDS 200 is an out-of-line passive system, it can only detect a potential security breach, log the information, and/or signal an alert to the user. A conventional IPS 100, on the other hand, may actively monitor and pass or drop packets that fail the IPS analysis. Therefore, the conventional IDS 200 is vulnerable to being overwhelmed by packet traffic between the NIC 208 and the network stack 212. If the data flow exceeds the capacity of the capturing application 240, packets will bypass the conventional IDS 200 entirely and pass on to their destination without inspection. Further, the IDS Application 232 may not know how many packets are bypassing the system, it may only be aware that it is running at its packet inspection capacity. This is a potential security problem not present with a conventional IPS 100 as depicted in FIG. 1 or an Inspection System 300 utilizing an IPS Application 544.

If a packet does not pass the analysis provided by the IDS application 232, the IDS application 232 may notify a kernel 220 that the packet should be dropped. Packets that pass are copied back to kernel space and then pass on through a firewall 224 and back out to the network 204 unless the kernel 220 drops the packets. This is the second copy of the packet made by the conventional IDS 200. If the failed packet passes the firewall 224 before the kernel 220 is notified that the packet does not comply with the IDS analysis, it may be too late and the packet will pass through the firewall 224 and back out into the network 204. Likewise, if the capturing application 240 or the IDS application 232 is overwhelmed by the quantity of packets passing through the IDS 200, and does not check each packet, the uninspected packets will continue on to their destination unimpeded. The packets that pass through the firewall 224 are allowed to pass back to the NIC 208 via the NIC driver 216 and back out to the network 204.

In the following discussion, the disclosed technology is set forth in the context of specific implementations for enhancing efficiency of certain inspection and filtering applications by eliminating the need to copy packets from kernel memory to user space memory and back to execute the filtering application functionality. While specific examples in this regard (e.g. IDS, IPS, and network security systems generally) are set forth below, it will be appreciated that various aspects of the disclosed technology are not limited to these examples but are more broadly applicable with respect to a variety of network monitoring applications. Other exemplary processes where the presently disclosed technology may be utilized include, but are not limited to, routing applications, network address translation (NAT), firewalling (network or application based), content filtering, email gateways, file sharing, and proxy servers.

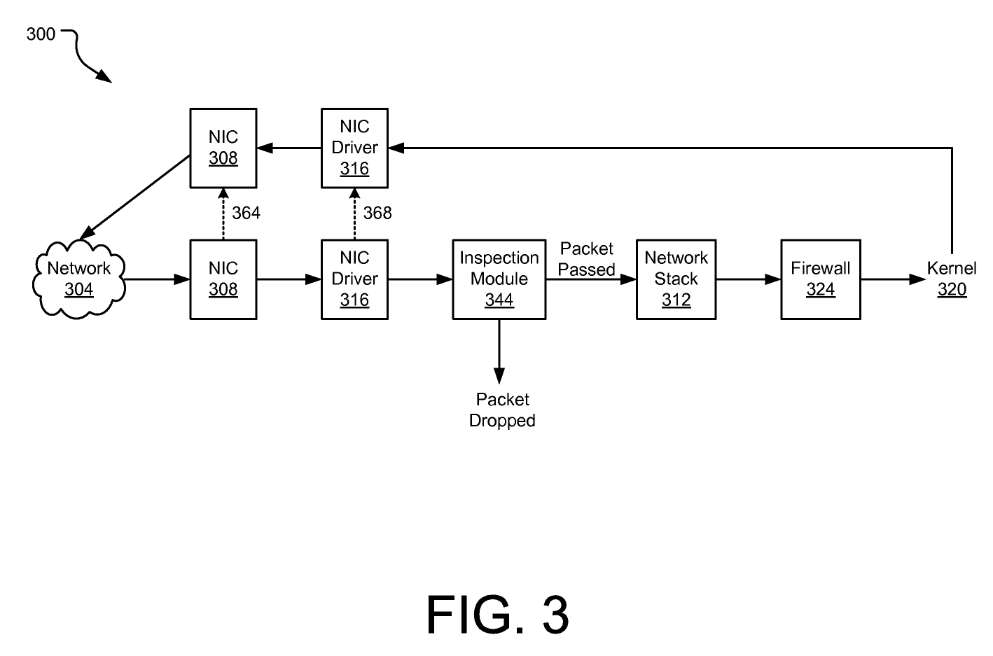

Referring now to FIG. 3, distinct from the conventional IPS 100 and conventional IDS 200 of FIGS. 1 and 2 respectively, an inspection system 300 according to the presently disclosed technology utilizes a shared segment of kernel space memory to store packets awaiting inspection and enables a user space application to directly access the memory for packet inspection. Therefore, only one copy of each packet is required for analysis. In an in-line embodiment of the presently disclosed technology, an inspection module 344 occupies a mandatory path through the system so that no packets are passed through a network stack 324 without undergoing inspection. In an out-of-line embodiment of the presently disclosed technology, the inspection module does not exist on a mandatory path and packets may bypass the inspection system 300, for example, if the packet flow exceeds the capacity of the inspection system 300.

The presently disclosed technology is set forth in the context of specific IDS and IPS application examples. However, while specific examples in this regard are set forth below, it will be appreciated that various aspects of the disclosed technology are not limited to these examples but are more broadly applicable with respect to a variety of network monitoring applications. Exemplary other network monitoring applications include traffic analysis (with or without associated filtering) and network use policy detection and/or enforcement systems.

In the embodiment depicted in FIG. 3, incoming packets from a network 304 enter the inspection system 300 via network interface cards (NICs) 308. The packets are then sent to a network stack 312 via a NIC driver 316. However, before any of the packets pass to the network stack 312, they undergo analysis by the inspection module 344.

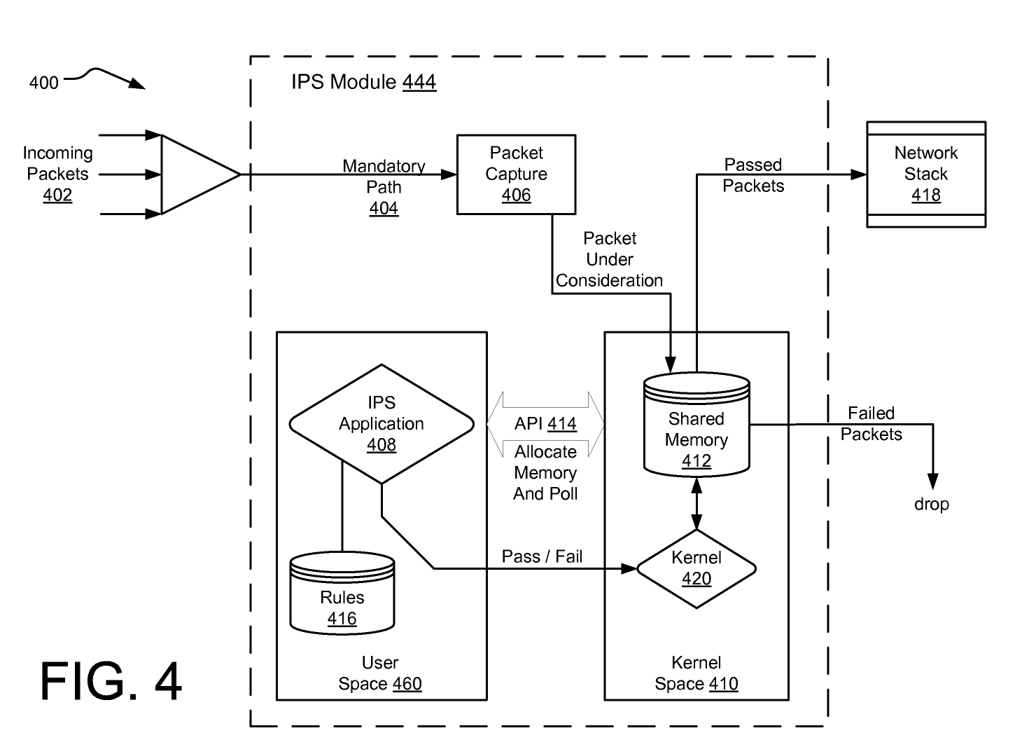

In an IPS implementation, the inspection module 344 occupies a mandatory path for packet traffic through the network and inspects every packet, or every one of a specific packet type. More specifically, the inspection module 344 analyzes each packet and marks each packet as passed or failed. Packets marked failed do not pass through the network stack and are either deleted or the memory space they occupy is reallocated by a kernel 320. Packets that are marked as passed pass through the network stack 312 and a firewall 324, if present, so long as the packets meet any firewall 324 requirements. The inspection module 344 in an IPS implementation is described in more detail below with reference to FIG. 4. The passed packets are then allowed to pass back to the NIC 308 via the NIC driver 316 and back out to the network 304.

In an IDS implementation, the inspection module 344 does not occupy a mandatory path for packet traffic. Consequently, packet traffic may bypass the inspection system 300 entirely if the inspection module 344 fails or is overloaded. This is distinct from the IPS implementation in that if the inspection module 344 in an IPS implementation fails or is overloaded, the packet traffic through the network slows or stops until the inspection module catches up or is repaired. The inspection module 344 analyzes packets and notifies the kernel 320 of any packets that fail analysis. The kernel 320 may drop any non-conforming packets at the firewall 324, if desired.

In one embodiment, the inspection module 344 may be configured to inspect only a certain set of packets. In this case, the inspection system 300 has a hardware-based fast-path 364 or a software-based fast-path 368 through the inspection system 300 for packets that are not to be inspected by the inspection module 344. This may increase the speed in which the inspection system 300 will operate by limiting the type of packets that the inspection module 300 inspects.

FIG. 4 illustrates the data flow in an IPS implementation of the inspection module 344 of FIG. 3. An inspection system 400 monitors traffic across a protected interface, for example, between a computer and a network such as a local area network. In such a context, incoming packets 402 are generally received, such as from a network interface card. The incoming packets 402 are directed via a mandatory path 404 to a packet capture process 406 associated with a kernel 420 of an operating system as will be described below. The packets are then stored in shared memory 412 of kernel space 410 for access by an IPS application 408.

The inspection system 400 as shown in FIG. 4 may be any system utilizing a mandatory path involved in monitoring and/or filtering traffic. In this regard, incoming and/or outgoing traffic may be monitored. Some examples of systems that may be utilized include IPS and entity policy enforcement systems (e.g., for preventing or restricting the transmission or receipt of personal, proprietary, competitive or otherwise sensitive information), etc. In the embodiment shown in FIG. 4, the IPS application 408 may access rules 416 for policing the traffic across the protected interface. Such rules may identify potential malware, effect entity policies or otherwise provide a basis for making a decision as to how to process a packet under consideration.

For example, the rules may implement a filtering determination. Thus, a packet that is suspicious based on analysis by the IPS application 408 may be dropped (deleted or allowed to expire from a buffer or other memory), passed unchanged to the network stack 418 in the case of incoming traffic, or modified prior to passage to the network stack 418. The packet may be modified, for example, to protect sensitive information. Thus, personal information such as a social security number may be deleted from the payload of a packet or location information (e.g., a geocode) may be generalized (e.g., rendered less specific by reducing the number of significant digits) to respect privacy rules.

In the context of the presently disclosed technology, this analysis and/or filtering can be executed with a minimum amount of packet copying and transfers, thereby improving processing efficiency and increasing throughput rates for given hardware and a given operating system/kernel. Conventionally, such applications have required that the packet first be copied into kernel space memory and then into user space memory for access by the application. The application would then process the packet and transfer the processed packet back to the kernel space memory, which would then result in the packet being stopped, passed to the network stack or modified and pass to the network stack as appropriate. The result was that PC class hardware and software were viewed as being insufficient to keep up with deployed data rates as discussed above.

In the illustrated system 400, a packet under consideration is stored in designated shared memory 412 of kernel space 410. An API 414 allows the IPS application 408 to establish and access the shared memory 412 so as to execute an analysis thereof. Based on the analysis, the IPS application 408 can then modify the packet stored in the shared memory 412 of kernel space 410 or direct the kernel 420 to pass or fail the packet, thereby significantly reducing the number of copies of the packet that are required to execute the filtering function and improving throughput rates.

Specifically, the illustrated module 444 can achieve data throughput rates of at least about 200 Mbps using PC class hardware and operating systems, thereby exceeding conventional performance in such environments and satisfying the requirements of many networks previously thought to require certain hardware/software solutions. Testing has shown that the IPS module 444 can achieve throughput rates of 1 Gbps using PC class hardware and a PC class operating system meeting a common performance goal for high performance networks. Moreover, the illustrated architecture can be implemented with shared memory for multiple application instances so as to support multi-core, e.g., quad core, scaling. In one implementation, the illustrated system has a throughput of at least about 2.33 Gbps, sufficient to support highly demanding environments.

The shared memory 412 of the kernel space 410 is established and accessed via the API 414. Specifically, the IPS application 408 implements the API 414 to request kernel allocation of the shared memory 412 within kernel space 410. This is generally a contiguous memory segment. If this request is successful, the kernel 420 makes the shared memory 412 available immediately.

When the IPS application 408 is available and active, incoming packets 402 are forwarded to the shared memory 412 by a packet capture process 406. Various proprietary or open source packet capture processes can be implemented in this regard including, for example, StillSecure Strata Guard. In the illustrated implementation, the incoming packets 402 are directed to the packet capture process 406, via a mandatory path 404. In particular, the packets 402 may be received from a NIC driver via a primary kernel call, which may vary depending on the operating system employed. In this regard, the presently disclosed technology may be implemented in connection with various proprietary or open source operating systems such as Microsoft Windows, MAC OS X and Linux. The kernel code can be extended to include a module option to enable in-line operation (e.g., set to 1 for in-line operation).

Upon receipt of a packet by the packet capture process 406, a determination is made as to whether the IPS application 408 is available and active. In some implementations, this may involve custom interfaces for use by such IPS applications 408 implemented via the PCAP library. Once this interface is used to indicate that an IPS application 408 is available and active, the packet is forwarded to the shared memory 412. Otherwise, the packet may be either passed to the network stack 418 (fail open) or dropped (fail closed) based on a user-configurable setting. Again, the kernel code can be extended to include a module option for this setting (e.g., set to 1 for fail open or 0 for fail closed).

The IPS application 408, when active, continually polls the shared memory 412 via API 414. In this manner, the inspection application 408 directly inspects the new data. The inspection process depends on the nature of the IPS application 408, but the application may, for example, search for patterns that should be removed or replaced (e.g., sensitive information such as social security numbers). The IPS application 408 may also search streams of packets for sequences that should be removed or replaced even when the individual packets themselves pass the inspection. If data that should be removed is found, it may be replaced with null data. If data is found that should be replaced that data is updated with new data. In this regard, if the new data would cause the packet to become fragmented (e.g., because the new data exceeds the Maximum Transit Unit or MTU), this may be detected by the IPS application 408, which causes the new data to be spread over multiple packets. That is, the current packet can be updated up to the limit of the MTU. A partial watch and replace can then be implemented on subsequent packet data.

If no data pattern is found that requires removal or replacement, the packet contents are left unaltered. In any case, the kernel 420 may be notified of the verdict (the result of the pass/fail determination). In the case of a pass determination, the kernel 420 allows the packet (modified or otherwise) to continue through the network stack 418. Otherwise, the packet is dropped (e.g., the kernel de-allocates or deletes the associated memory cell).

Boundary conditions are properly banded by both the user space implementation library (PCAP) and the kernel space implementation. For example, upon disconnect of the IPS application 408, the shared memory 412 that was in use is properly turned down. If an additional application (e.g., another interface of the same process) is still active, it will receive an adjusted load of packets. If no additional application is active (e.g., the application under consideration in the last to exit), the remaining packets in the shared memory 412 can be processed in accordance with the current setting for use when no applications 408 are active (e.g., fail open or fail closed).

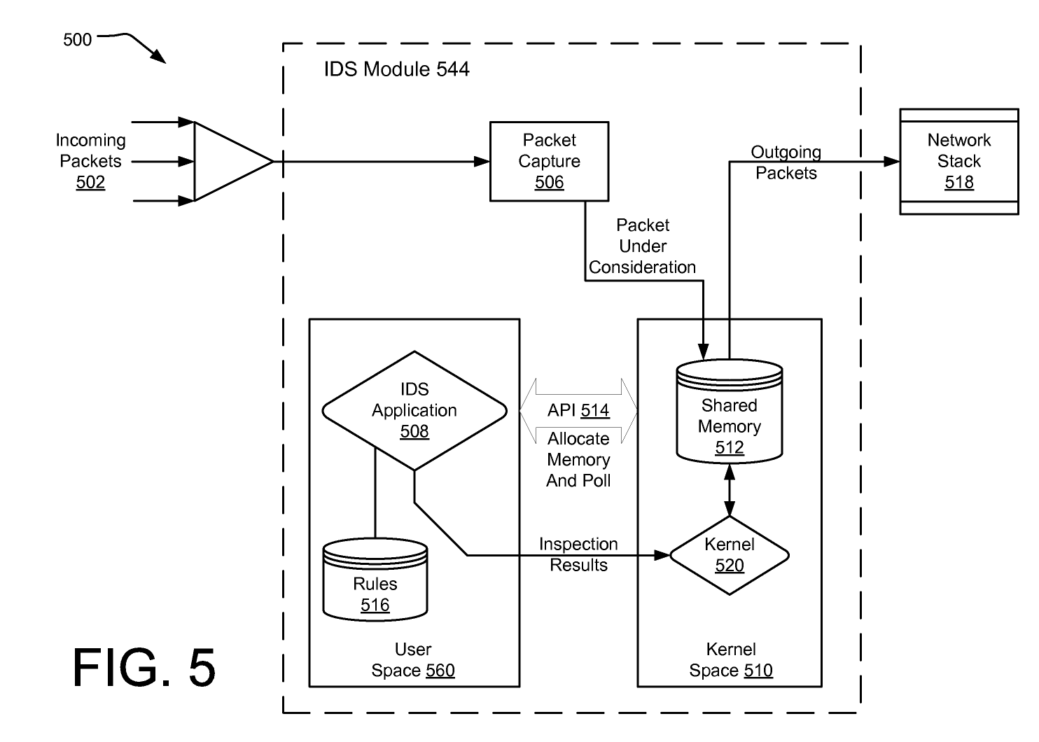

FIG. 5 illustrates the data flow in an IDS implementation of the inspection module 344 of FIG. 3. An inspection system 500 monitors traffic across a protected interface, for example, between a computer and a network such as a local area network. In such a context, incoming packets 502 are generally received from a network interface card. The incoming packets 502 are directed to a packet capture process 506 associated with a kernel 520 of an operating system as will be described below. The packets are then stored in shared memory 512 of kernel space 510 for access by an IDS application 508.

The inspection system 500 as shown in FIG. 5 may be any out-on-line system not utilizing a mandatory path involved in monitoring traffic across a protected interface. In this regard, incoming and/or outgoing traffic may be monitored. Some examples of systems that may be utilized include IDS and entity policy detection systems (e.g., for detecting the transmission or receipt of personal, proprietary, competitive or otherwise sensitive information), etc. In the embodiment shown in FIG. 5, the IDS application 508 may access rules 516 for policing the traffic across the protected interface. Such rules may identify potential malware, effect entity policies or otherwise provide a basis for making a decision as to how to process a packet under consideration.

In the illustrated system 500, a packet under consideration is stored in designated shared memory 512 of kernel space 510. An API 514 allows the IDS application 508 to establish and access the shared memory 512 so as to execute an analysis thereof. Based on the analysis, the IDS application 508 can then notify the kernel 520 of the results or store the results.

The shared memory 512 of the kernel space 510 is established and accessed via the API 514. Specifically, the IDS application 508 implements the API 514 to request kernel allocation of the shared memory 512 within kernel space 510. This is generally a contiguous memory segment. If this request is successful, the kernel 520 makes the shared memory 512 available immediately.

When the IDS application 508 is available and active, incoming packets 502 are forwarded to the shared memory 512 by a packet capture process 506. Various proprietary or open source packet capture processes can be implemented in this regard including, for example, StillSecure Strata Guard. In the illustrated implementation, the incoming packets 502 are directed to the packet capture process 506. In particular, the packets 502 may be received from a NIC driver via a primary kernel call, which may vary depending on the operating system employed.

Since in this embodiment the packet capture process 506 is not in-line, the packet capture process 506 may allow the IDS system 500 to drop packets if the IDS module 544 cannot keep up with the flow of packets in the network. Dropped packets completely bypass the IDS system 500 and continue on to their destination uninspected. Further, due to out-of-line orientation of the IDS system 500, the data stored in the shared memory 512 may become fragmented. More specifically, the data sequences may not be linear due to packet loss. The presently disclosed technology may be implemented in connection with various proprietary or open source operating systems such as Microsoft Windows, MAC OS X and Linux. The kernel code can be extended to include a module option to enable in-line operation (e.g., set to 1 for in-line operation).

Upon receipt of a packet by the packet capture process 506, a determination is made as to whether the IDS application 508 is available and active. In some implementations, this may involve custom interfaces for use by such IDS applications 508 implemented via the PCAP library. Once this interface is used to indicate that an IDS application 508 is available and active, the packet is forwarded to the shared memory 512. Otherwise, the packet may be either passed to the network stack 518 (fail open) or dropped (fail closed) based on a user-configurable setting. Again, the kernel code can be extended to include a module option for this setting (e.g., set to 1 for fail open or 0 for fail closed).

The IDS application 508, when active, continually polls the shared memory 512 via API 514. In this manner, the IDS application 508 directly inspects the new data. The inspection process depends on the nature of the IDS application 508, but the application may, for example, search for patterns that should be removed or replaced (e.g., sensitive information such as social security numbers). The IDS application 408 may also search streams of packets for sequences that should be removed or replaced even when the individual packets themselves pass the inspection. The packets are automatically released to the network stack 518, even if they failed the inspection or were missed by the IDS application 508. However, the kernel 520 may be notified of the inspection results. If the kernel 520 receives instructions prior to the packet passing through the network stack 518, the kernel 520 may drop the packet (e.g., the kernel de-allocates or deletes the associated memory cell).

Boundary conditions are properly banded by both the user space implementation library (PCAP) and the kernel space implementation. For example, upon disconnect of the IDS application 508, the shared memory 512 that was in use is properly turned down. If an additional application (e.g., another interface of the same process) is still active, it will receive an adjusted load of packets. If no additional application is active (e.g., the application under consideration in the last to exit), the remaining packets in the shared memory 512 can be processed in accordance with the current setting for use when no applications 508 are active (e.g., fail open or fail closed).

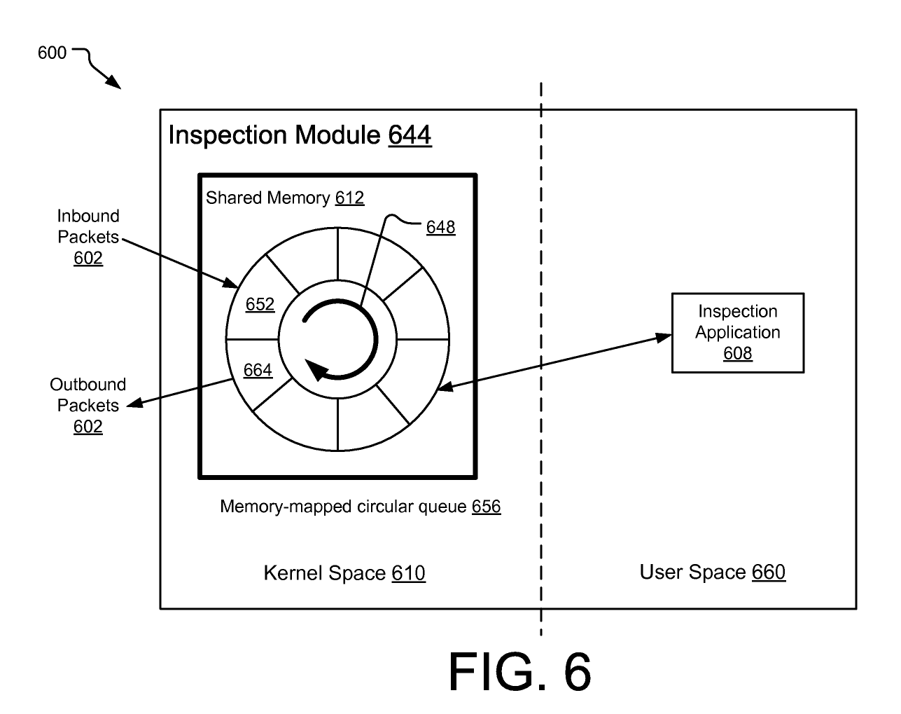

FIG. 6 illustrates the shared memory 612 and the interaction between kernel space 410, 510 and user space 460, 560 as contemplated in FIGS. 4 and 5. In the embodiment shown in FIG. 6, an inbound packet 602, typically from a NIC, enters the shared memory 612 by way of an entry port 652 of a memory-mapped circular queue 656. The circular queue 656 exists in memory shared between kernel space 610 and user space 660. All packets 602 enter the circular queue 656 through the entry port 652 and exit the circular queue 656 through the exit port 664.

As the packets 602 travel through the circular queue 656, an inspection application 608 continually polls the circular queue 656 in the shared memory 612 for new packets 602. New packets 602 are analyzed by the inspection application 608 without leaving the circular queue 656 and are marked as pass or fail if the inspection application is an IPS application. When the packets 602 reach the exit port 664 of the circular queue 656, they are dropped if they failed the IPS application analysis or passed on through the network stack if they are passed the IPS application analysis. Similarly, if the inspection application 608 is an IDS application, new packets 602 may be marked as inspected after being inspected by the IDS application. However, when the packets 602 reach the exit port 664 of the circular queue 656, they are passed on through the network stack regardless of whether they were marked as inspected.

In an IPS application, if a packet 602 is not marked because the inspection application 608 has yet to perform an analysis on it, the circular queue 656 stops, and waits for the inspection application 608 to perform an analysis on the packet 602 at the exit port 664. Consequently, each packet 602 is analyzed before exiting the circular queue 656 and the circular queue 656 automatically stops or slows if the inspection application 608 is having trouble keeping up with the flow of packets 602 through the circular queue 656.

The circular queue (or ring buffer) 656 is only an example of a queuing application; there may be other suitable queuing applications. Further, while IPS and IDS applications are described in detail, any application could be used to poll data within the shared memory 612.

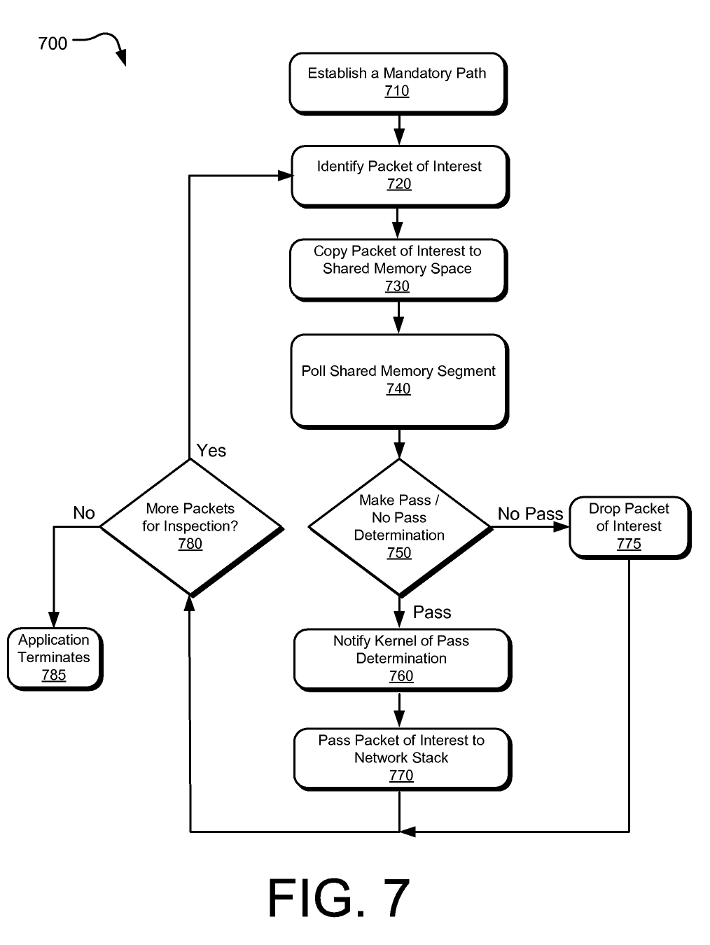

By way of summary, a corresponding IPS traffic inspection and filtering process 700 is shown in FIG. 7. The process 700 is initiated by establishing 710 a mandatory path through an appropriately configured packet capture process of a kernel for all (or a desired portion of) incoming and/or outgoing packets with respect to a protected interface. In this regard, the IPS module option noted above for enabling in-line operation can be set to the appropriate value. A packet of interest is then identified 720 and copied 730 to shared memory space of the kernel. In particular when the packet capture process is notified that a filtering application is available and active, incoming (and/or outgoing, depending on the configuration) packets may be mapped to a shared memory segment designated for that application.

The filtering application then polls 740 the shared memory segment. For example, such polling may be conducted continually via an API configured to enable access by the application to the designated kernel space memory. A pass/fail (and/or data remove/replace) determination 750 is then made with respect to the packet by the application. In the case of a pass determination, the kernel is notified 760 (e.g., via populating a flag or field with a defined value) of the determination and the packet is passed 770 through the network stack. Otherwise, the packet is discarded or dropped 775, for example, by de-allocating the associated memory cell. This process continues until a determination is made 780 that there are no further packets for inspection (e.g., the application terminates 785).

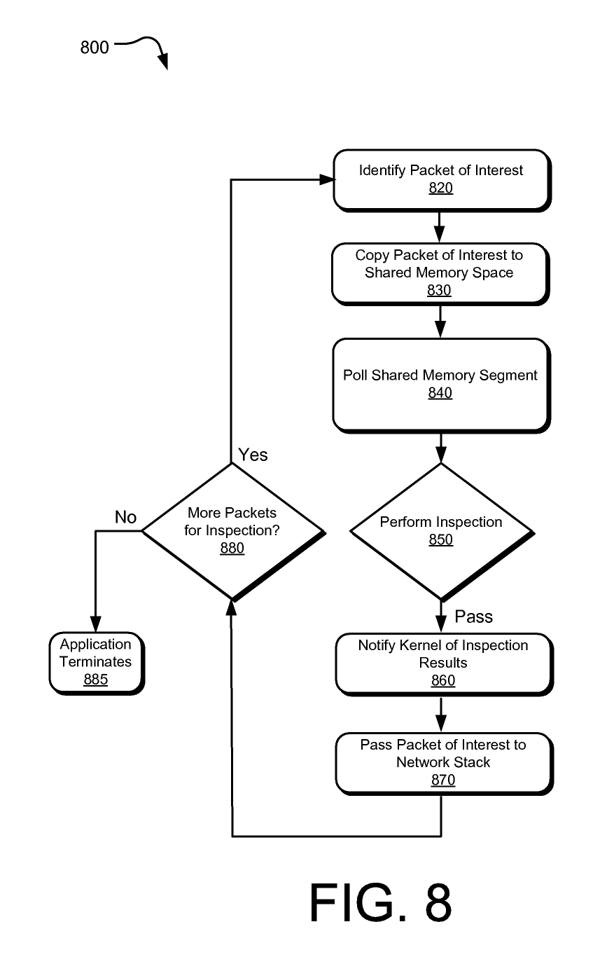

By way of summary, a corresponding IDS traffic inspection process 800 is shown in FIG. 8. The process 800 is initiated by identifying a packet of interest 820 and copying the packet of interest to shared memory space of the kernel 830. In particular when the packet capture process is notified that a filtering application is available and active, incoming (and/or outgoing, depending on the configuration) packets may be mapped to a shared memory segment designated for that application.

The inspection application then polls the shared memory segment 840. For example, such polling may be conducted continually via an API configured to enable access by the application to the designated kernel space memory. Then the packet of interest is inspected by the application 850. Optionally, the application may notify (e.g., via populating a flag or field with a defined value) the kernel that the packet was inspected 860. Regardless of the result of the inspection, the packet is automatically passed through the network stack unless the kernel discards or drops it. This process continues until a determination is made 880 that there are no further packets for inspection (e.g., the application terminates 885).

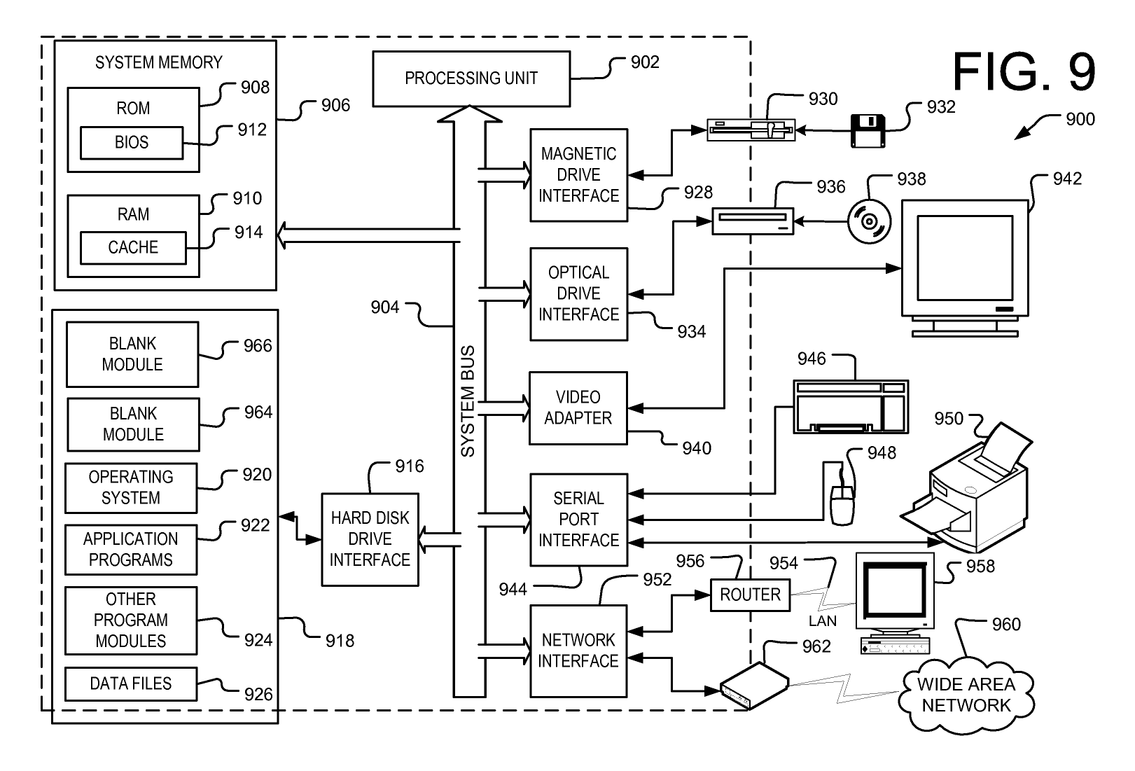

An exemplary computer system 900 for implementing the network monitoring, traffic analysis, and/or filtering processes above is depicted in FIG. 9. The computer system 900 of a sender or a recipient may be a personal computer (PC), a workstation, a notebook or portable computer, a tablet PC, a handheld media player (e.g., an MP3 player), a smart phone device, a video gaming device, or a set top box, with internal processing and memory components as well as interface components for connection with external input, output, storage, network, and other types of peripheral devices. Internal components of the computer system in FIG. 9 are shown within the dashed line and external components are shown outside of the dashed line. Components that may be internal or external are shown straddling the dashed line. Alternatively to a PC, the computer system 900, for example, for running the network monitoring, traffic analysis, and/or filtering application, may be in the form of any of a server, a mainframe computer, a distributed computer, an Internet appliance, or other computer devices, or combinations thereof.

In any embodiment or component of the system described herein, the computer system 900 includes a processor 902 and a system memory 906 connected by a system bus 904 that also operatively couples various system components. There may be one or more processors 902, e.g., a single central processing unit (CPU), or a plurality of processing units, commonly referred to as a parallel processing environment (for example, a dual-core, quad-core, or other multi-core processing device). The system bus 904 may be any of several types of bus structures including a memory bus or memory controller, a peripheral bus, a switched-fabric, point-to-point connection, and a local bus using any of a variety of bus architectures. The system memory 906 includes read only memory (ROM) 908 and random access memory (RAM) 910. A basic input/output system (BIOS) 912, containing the basic routines that help to transfer information between elements within the computer system 900, such as during start-up, is stored in ROM 908. A cache 914 may be set aside in RAM 910 to provide a high speed memory store for frequently accessed data.

A hard disk drive interface 916 may be connected with the system bus 904 to provide read and write access to a data storage device, e.g., a hard disk drive 918, for nonvolatile storage of applications, files, and data. A number of program modules and other data may be stored on the hard disk 918, including an operating system 920, one or more application programs 922, and data files 924. In an exemplary implementation, the hard disk drive 918 may store the media service, recording, and synchronization application 926, the media data repository 964 for storage of media selections for presentation to a sender, and the audio recording data repository 966 for storing audio performances recorded by a sender according to the exemplary processes described herein above. Note that the hard disk drive 918 may be either an internal component or an external component of the computer system 900 as indicated by the hard disk drive 918 straddling the dashed line in FIG. 9. In some configurations, there may be both an internal and an external hard disk drive 918.

The computer system 900 may further include a magnetic disk drive 930 for reading from or writing to a removable magnetic disk 932, tape, or other magnetic media. The magnetic disk drive 930 may be connected with the system bus 904 via a magnetic drive interface 928 to provide read and write access to the magnetic disk drive 930 initiated by other components or applications within the computer system 900. The magnetic disk drive 930 and the associated computer-readable media may be used to provide nonvolatile storage of computer-readable instructions, data structures, program modules, and other data for the computer system 900.

The computer system 900 may additionally include an optical disk drive 936 for reading from or writing to a removable optical disk 938 such as a CD ROM or other optical media. The optical disk drive 936 may be connected with the system bus 904 via an optical drive interface 934 to provide read and write access to the optical disk drive 936 initiated by other components or applications within the computer system 900. The optical disk drive 930 and the associated computer-readable optical media may be used to provide nonvolatile storage of computer-readable instructions, data structures, program modules, and other data for the computer system 900.

A display device 942, e.g., a monitor, a television, or a projector, or other type of presentation device may also be connected to the system bus 904 via an interface, such as a video adapter 940 or video card. Similarly, audio devices, for example, external speakers or a microphone (not shown), may be connected to the system bus 904 through an audio card or other audio interface (not shown).

In addition to the monitor 942, the computer system 900 may include other peripheral input and output devices, which are often connected to the processor 902 and memory 906 through the serial port interface 944 that is coupled to the system bus 906. Input and output devices may also or alternately be connected with the system bus 904 by other interfaces, for example, a universal serial bus (USB), an IEEE 1394 interface (“Firewire”), a parallel port, or a game port. A user may enter commands and information into the computer system 900 through various input devices including, for example, a keyboard 946 and pointing device 948, for example, a mouse. Other input devices (not shown) may include, for example, a joystick, a game pad, a tablet, a touch screen device, a satellite dish, a scanner, a facsimile machine, a microphone, a digital camera, and a digital video camera.

Output devices may include a printer 950 and one or more loudspeakers 970 for presenting the audio performance of the sender. Other output devices (not shown) may include, for example, a plotter, a photocopier, a photo printer, a facsimile machine, and a press. In some implementations, several of these input and output devices may be combined into single devices, for example, a printer/scanner/fax/photocopier. It should also be appreciated that other types of computer-readable media and associated drives for storing data, for example, magnetic cassettes or flash memory drives, may be accessed by the computer system 900 via the serial port interface 944 (e.g., USB) or similar port interface.

The computer system 900 may operate in a networked environment using logical connections through a network interface 952 coupled with the system bus 904 to communicate with one or more remote devices. The logical connections depicted in FIG. 9 include a local-area network (LAN) 954 and a wide-area network (WAN) 960. Such networking environments are commonplace in home networks, office networks, enterprise-wide computer networks, and intranets. These logical connections may be achieved by a communication device coupled to or integral with the computer system 900. As depicted in FIG. 9, the LAN 954 may use a router 956 or hub, either wired or wireless, internal or external, to connect with remote devices, e.g., a remote computer 958, similarly connected on the LAN 954. The remote computer 958 may be another personal computer, a server, a client, a peer device, or other common network node, and typically includes many or all of the elements described above relative to the computer system 900.

To connect with a WAN 960, the computer system 900 typically includes a modem 962 for establishing communications over the WAN 960. Typically the WAN 960 may be the Internet. However, in some instances the WAN 960 may be a large private network spread among multiple locations, or a virtual private network (VPN). The modem 962 may be a telephone modem, a high speed modem (e.g., a digital subscriber line (DSL) modem), a cable modem, or similar type of communications device. The modem 962, which may be internal or external, is connected to the system bus 918 via the network interface 952. In alternate embodiments the modem 962 may be connected via the serial port interface 944. It should be appreciated that the network connections shown are exemplary and other means of and communications devices for establishing a network communications link between the computer system and other devices or networks may be used.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products. In one implementation, a computer program product is provided as a computer-readable medium storing an encoded computer program executable by a computer system. Another implementation of a computer program product may be provided in a computer data signal embodied in a carrier wave by a computing system and encoding the computer program. Other implementations are also described and recited herein.

All directional references (e.g., proximal, distal, upper, lower, upward, downward, left, right, lateral, front, back, top, bottom, above, below, vertical, horizontal, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order, and relative sizes reflected in the drawings attached hereto may vary.

The above specification and examples provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed:

1. A method of monitoring content in a network, comprising:
allocating a shared kernel memory segment of a kernel for access by a user space application;
using the allocated shared kernel memory segment to store packets for processing by the user space application; and
operating the user space application to perform an inspection on at least a packet in the shared kernel memory segment.

2. The method as set forth in claim 1, further comprising:
operating the user space application to provide an output dependent on a result of the inspection.

3. The method as set forth in claim 1, wherein the step of allocating comprises:
receiving a request from the user space application via an API regarding allocation of the shared kernel memory segment; and
allocating the shared kernel memory segment responsive to the request.

4. The method as set forth in claim 1, wherein the step of using comprises:
monitoring a network interface; and
directing packets passing across the interface to the shared kernel memory segment.

5. The method as set forth in claim 1, wherein the step of first operating comprises:
repeatedly polling the shared kernel memory segment for new packets; and
performing the inspection on the new packets.

6. The method as set forth in claim 2, wherein a result of the inspection is a pass/fail determination, and the step of second operating comprises providing an output to the kernel indicating whether the packet should pass through a network stack.

7. The method as set forth in claim 1, wherein a result of the inspection is a pass/fail determination, and the method further comprises de-allocating a portion of shared kernel memory associated with the packet.

8. The method as set forth in claim 2, wherein the step of second operating comprises providing an output to the kernel indicating the results of the inspection.

9. The method as set forth in claim 1, wherein the step of first operating comprises: identifying a packet subject to a rule regarding transmission across a monitored interface.

10. The method as set forth in claim 1, further comprising modifying the packet based on the inspection.

11. The method as set forth in claim 10, wherein the step of modifying comprises one of removing and replacing the packet.

12. A method as set forth in claim 1, wherein the user space application comprises one of an IDS, an IPS and a network use policy enforcement application.

13. A method as set forth in claim 1, wherein the user space application comprises one of a routing application, network address translation application, firewall application, content filtering application, file sharing application, email gateway, and proxy server.

14. An apparatus for use in monitoring a network, comprising:
a kernel including a shared kernel memory segment for access by a user space application;
an interface, associated with the kernel, for receiving packets for storage in the shared kernel memory segment for processing by the user space application; and
a processor operative for running the user space application to perform an inspection on at least a packet in the shared kernel memory segment.

15. An apparatus as set forth in claim 14, wherein the processor is further operative for running the kernel to process the packet in a manner dependent on a result of the inspection.

16. An apparatus as set forth in claim 14, further comprising an API for use by the user space application in establishing and accessing the shared kernel memory segment.

17. An apparatus as set forth in claim 16, wherein the API is operative to allow the user space application to execute the inspection free from copying the at least one packet into user space memory.

18. An apparatus as set forth in claim 14, wherein a result of the inspection is communicated to the kernel.

19. An apparatus as set forth in claim 14, wherein a result of the inspection is a pass/fail determination and the processor operates the kernel to selectively pass the at least one packet through a network stack or drop the at least one packet based on the pass/fail determination.

20. A method as set forth in claim 14, wherein the user space application comprises one of an IDS, an IPS and a network use policy enforcement application.

21. A method as set forth in claim 14, wherein the user space application comprises one of a routing application, network address translation application, firewall application, content filtering application, file sharing application, email gateway, and proxy server.

22. A method for use in monitoring a network, comprising the steps of:
establishing a mandatory path for packet transmission in relation to a protected interface of the network, the mandatory path being implemented by a packet capture process of an operating system;
monitoring the mandatory path to identify a packet of interest for inspection by a user space process;
employing the user space process, free from copying the packet into user space, to perform an inspection on the packet and make a pass/fail determination regarding the packet; and
operating the packet capture process to selectively allow or disallow the packet of interest to pass the protected interface of the network based on the pass/fail determination.

23. A method as set forth in claim 22, wherein the step of establishing comprises extending a packet capture process of a kernel to enable in-line operation of the user space process.

24. A method as set forth in claim 22, wherein the user space process comprises one of an IDS, an IPS and a network use policy enforcement process.

25. A method as set forth in claim 22, wherein the user space process comprises one of a routing process, network address translation process, firewall process, content filtering process, file sharing process, email gateway, and proxy server.

26. An apparatus for use in monitoring a network, comprising:
a packet capture module of an operating system configured to be a mandatory path for packet transmission in relation to a protected interface of the network;
a memory segment for storing a copy of a packet of interest from the packet capture module;
a user space inspection module for performing an inspection of the packet of interest of the memory segment so as to make a pass/fail determination regarding the packet; and
an interface for communicating a result of the pass/fail determination to the packet capture module, wherein the packet capture module can selectively allow or disallow the packet of interest to pass the protected interface of the network based on the pass/fail determination.

27. An apparatus as set forth in claim 26, wherein the memory segment is a kernel space memory segment.

28. An apparatus as set forth in claim 26, wherein the user space inspection module is operative for performing the inspection free from copying the packet of interest into user space memory.
